(19) United States
(12) Patent Application Publication
(10) Pub. No.: US 2022/0067645 A1
(43) Pub. Date: Mar. 3, 2022

(54) Systems and Methods for Automatic Determination of a Packing Configuration to Pack Items in Shipping Boxes

(71) Applicant: Walmart Apollo, LLC, Bentonville, AR (US)

(72) Inventor: Murali Krishna Gopalakrishnan, Irving, TX (US)

(21) Appl. No.: 17/004,478

(22) Filed: Aug. 27, 2020

(51) Int. Cl. G06Q 10/08; G06Q 10/06; G06N 20/00; G05B 19/4155; G06K 9/62

(52) U.S. Cl. CPC G06Q 10/0832; G06Q 10/0838; G06Q 10/06316; G05B 2219/50391; G05B 19/4155; G06K 9/6202; G05B 2219/32389; G06N 20/00

(57) ABSTRACT

In some embodiments, apparatuses and methods are provided herein useful to automatically determine packing configurations. In some embodiments, there is provided a system for automatically determining packing configurations for packing items into shipping boxes including a plurality of human operated packing stations; a plurality of robot operated packing stations; a database; and a control circuit configured to execute one or more machine learning models to: execute a first feedback loop; provide adjusted first packing configuration to one or more of the plurality of human operated packing stations; execute a second feedback loop; and determine data corresponding to human operator deviations from the adjusted first packing configuration; and provide the adjusted first packing configuration to one or more of the plurality of human operated packing stations and the plurality of robot operated packing stations to pack additional orders of a first set of items into one or more shipping boxes.

### TECHNICAL FIELD

This invention relates generally to determining one or more packing configurations to pack items in shipping boxes.

### BACKGROUND

Generally, a retail order for one or more retail items are packed manually by an associate based on a packing configuration determined by the associate. In another retail order for the same retail items, another associate may pack the same retail items using a different packing configuration. Overall, packing configurations are mainly based on each of the particular associate's determination and can lead to wide inefficiencies in packaging and shipping retail items, which can lead to increased cost to the retail store.

### BRIEF DESCRIPTION OF THE DRAWINGS

Disclosed herein are embodiments of systems, apparatuses and methods pertaining to automatically determining packing configurations for packing items into shipping boxes. This description includes drawings, wherein:

FIG. 1 illustrates a simplified block diagram of an exemplary system for automatically determining packing configurations for packing items into shipping boxes in accordance with some embodiments;

FIG. 2 shows a flow diagram of an exemplary process of automatically determining packing configurations for packing items into shipping boxes in accordance with some embodiments;

FIG. 3 shows a flow diagram of an exemplary process of automatically determining packing configurations for packing items into shipping boxes in accordance with some embodiments;

FIG. 4 illustrates an exemplary system for use in implementing methods, techniques, devices, apparatuses, systems, servers, sources and automatically determining packing configurations for packing items into shipping boxes, in accordance with some embodiments;

FIG. 5 shows a flow diagram of an exemplary process of automatically determining packing configurations for packing items into shipping boxes in accordance with some embodiments;

FIG. 6 shows a flow diagram of an exemplary process of automatically determining packing configurations for packing items into shipping boxes in accordance with some embodiments; and

FIG. 7 shows a flow diagram of an exemplary process of automatically determining packing configurations for packing items into shipping boxes in accordance with some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to various embodiments, systems, apparatuses and methods are provided herein useful for automatically determining packing configurations for packing items into shipping boxes. In some embodiments, a system for automatically determining packing configurations for packing items into shipping boxes includes a plurality of human operated packing stations; a plurality of robot operated packing stations; a database; and/or a control circuit. In some embodiments, the database stores item data, shipping box data, and/or packing configuration data including packing configurations for packing combinations of items into shipping boxes. In some embodiments, the control circuit is coupled to the database, the plurality of human operated packing stations and/or the plurality of robot operated packing station. By one approach, the control circuit may execute one or more machine learning models to execute a first feedback loop to compare past packing configurations of a first set of item with a first packing configuration for the first set of items and adjust the first packing configuration based on this comparison. In some embodiments, the control circuit provides the adjusted first packing configuration to one or more of the plurality of human operated packing stations for a human to pack the first set of items into one or more shipping boxes in accordance with the adjusted first packing configuration. In some configurations, the control circuit executes a second feedback loop to receive data from the human operated packing stations including whether the human operators packed the first set of items in accordance with the adjusted first packing configuration. In some embodiments, the control circuit determines data corresponding to human operator deviations from the adjusted first packing configuration based on the data received from the human operated packing stations. In some embodiments, the control circuit provides the adjusted first packing configuration to one or more of the plurality of human operated packing stations and/or the plurality of robot operated packing stations to pack additional orders of the first set of items into the one or more shipping boxes.

In some embodiments, a method for automatically determining packing configurations for packing items into shipping boxes at a retail facility (e.g., a fulfillment center, a retail store, a distribution center, etc.). The method includes executing, by a control circuit coupled to a database, a plurality of human operated packing stations, and/or a plurality of robot operated packing stations, a first feedback loop to compare past packing configurations of a first set of item with a first packing configuration for the first set of items and adjusting the first packing configuration based on this comparison. By one approach, the database may store item data, shipping box data, and/or packing configuration data including packing configurations for packing combinations of items into shipping boxes. In some embodiments, the method includes providing, by the control circuit, the adjusted first packing configuration to one or more of the plurality of human operated packing stations for a human to pack the first set of items into one or more shipping boxes in accordance with the adjusted first packing configuration. In some embodiments, the method includes executing, by the control circuit, a second feedback loop to receive data from the human operated packing stations including whether the human operators packed the first set of items in accordance with the adjusted first packing configuration and determining data corresponding to human operator deviations from the adjusted first packing configuration based on the data received from the human operated packing stations. In some embodiments, the method includes providing, by the control circuit, the adjusted first packing configuration to one or more of the plurality of human operated packing stations and/or the plurality of robot operated packing stations to pack additional orders of the first set of items into the one or more shipping boxes.

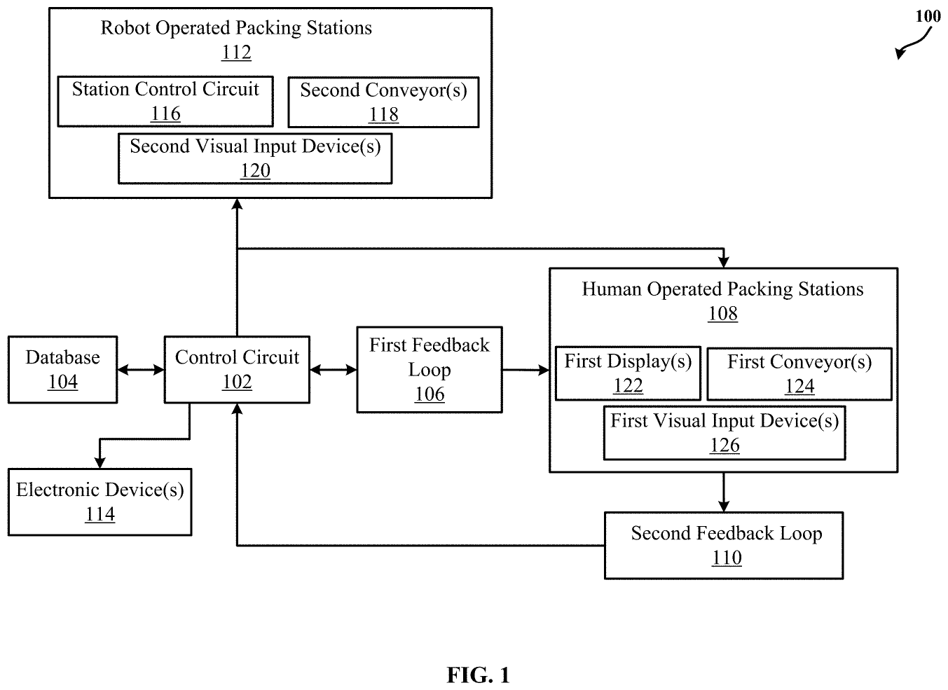

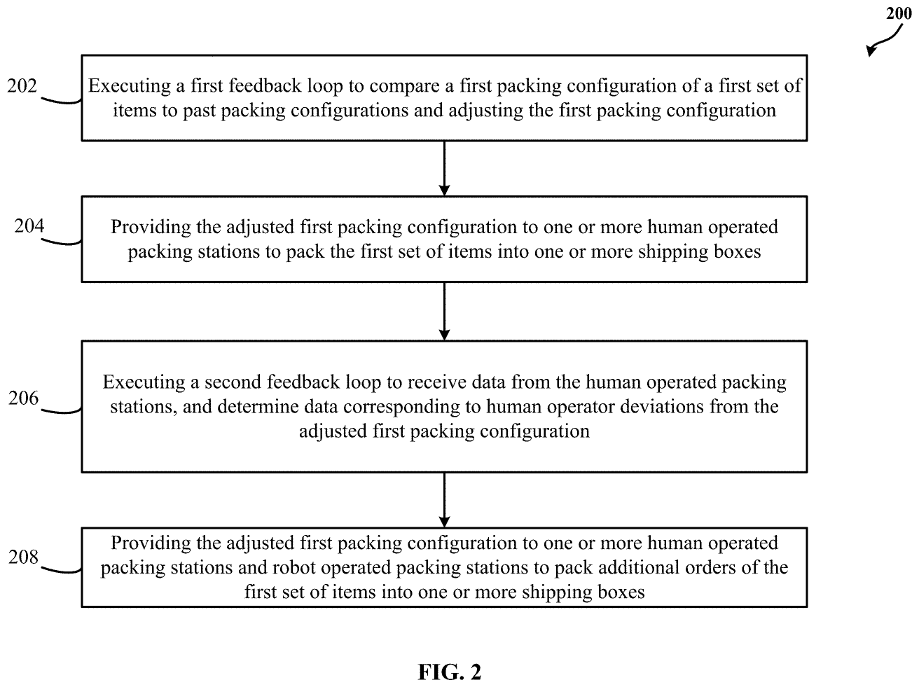

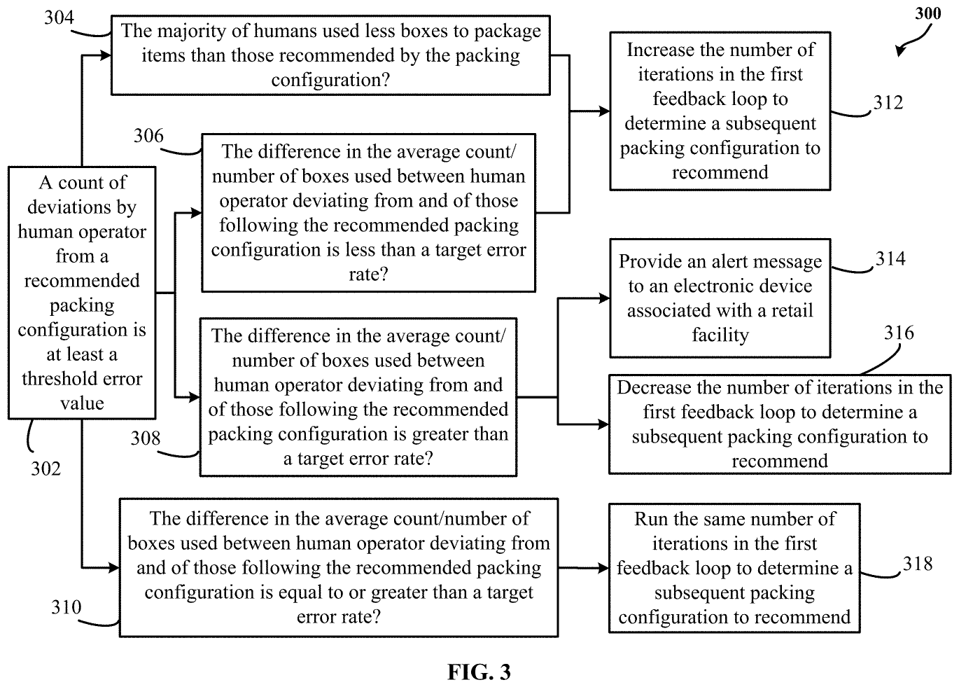

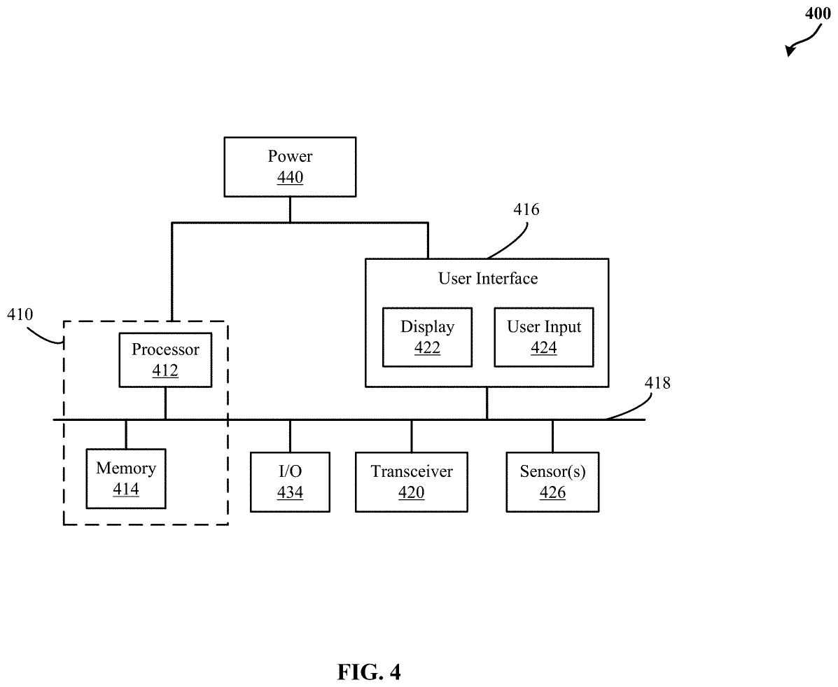

To illustrate, FIGS. 1-7 are described below. FIG. 1 illustrates a simplified block diagram of an exemplary system 100 for automatically determining packing configurations for packing items into shipping boxes in accordance with some embodiments. FIG. 2 shows a flow diagram of an exemplary process (or method) 200 of automatically determining packing configurations for packing items into shipping boxes in accordance with some embodiments. FIG. 3 shows a flow diagram of an exemplary process (or method) 300 of automatically determining packing configurations for packing items into shipping boxes in accordance with some embodiments. In particular, FIG. 3 illustrates steps included in the method 300 when a count of deviations by human operator from a recommended packing configuration is equal to and/or greater than a threshold error value. In other words, the method 300 describes one or more steps that can be executed by the control circuit 102 in response to a confidence level that is less than a threshold value. One or more steps in one or more of methods 200 and 300 may be implemented in the system 100 of FIG. 1. FIG. 4 illustrates an exemplary system for use in implementing methods, techniques, devices, apparatuses, systems, servers, sources and automatically determining packing configurations for packing items into shipping boxes, in accordance with some embodiments.

In some embodiments, the system 100 includes a plurality of human operated packing stations 108; a plurality of robot operated packing stations 112; a database 104; and/or a control circuit 102. For example, a human operated packing station 108 and a robot operated packing station 112 are areas in a retail facility (e.g., a fulfillment center, a retail store, a distribution center, etc.) that are used to pack items associated with purchase orders submitted/filed by customers. By one approach, in a human operated packing station 108, packing of items may be performed completely and/or partially by a human (e.g., an associate of a retail store, a fulfillment center, a contractor, a distribution center, etc.). In some embodiments, a human operated packing station 108 includes one or more first displays 122, first conveyors 124, and/or first visual input devices 126. In some configurations, a robot operated packing station 112 may include a station control circuit 116, second conveyors 118, and/or second visual input devices 120. By another approach, in a robot operated packing station 112, the packing of items is unassisted by a human. For example, electro-mechanical driven components are cooperatively controlled by the control circuit 102 and/or the station control circuit 116 and configured to take items on a second conveyor 118 and pack these items in one or more shipping boxes without assistance from a human. In some configurations, a first display 122 may include a cathode ray tube monitor, a liquid crystal display monitor, a light-emitting diode monitor, and a television monitor, among other types of display devices capable of electronically displaying or visually showing object, items, letters, numbers, symbols, drawings, figures, etc. In some configurations, a first conveyor 124 and/or a second conveyor 118 may include one or more conveyor systems including a belt conveyor, a chain conveyor, a flexible conveyor, a pneumatic conveyor, a spiral conveyor, a vertical conveyor, and a vibrating conveyor, among mechanical handling equipment capable of moving items from one location to another. In some configurations, a first visual input device 126 and/or a second visual input device 120 may include a camera, an optical sensor, a barcode scanner, and an optical character reader, among other types of electronic device capable of optically capturing one or more items, a scene, an electronic code, a QR code, a Universal Product Code (UPC), etc.

In some embodiments, a database 104 stores item data, shipping box data, and/or packing configuration data including packing configurations for packing combinations of items into shipping boxes. In some configurations, a database 104 includes one or more memory storage devices capable of electronic storage of data. For example, a memory storage device may include one or more random access memory (RAM), read only memory (ROM), hard disk drive, compact disc, DVD and Blu-ray discs, USB flash drive, secure digital card (SD card), solid state drive (SSD), and/or cloud storage, to name a few. In another example, an item data may include UPC code and/or QR code of a retail item for purchase at a retail store, a description and/or a physical dimensions of the retail item, and/or shipping requirements of the retail item, to name a few. In another example, a shipping box data may include a type of shipping box (e.g., a folding carton box, a rigid box, a corrugated box, a full overlap box, a roll end tuck top box, a collapsible box, a shoulder box, a regular slotted container box, and/or a mailer boxes, to name a few), physical dimensions of the box, maximum weight the box can hold, etc. In another example, a packing configuration data may include a quantity of items to pack in a particular box, instructions of packing orientations and/or arrangements of items in a box, and/or visual and/or pictorial representations of packing orientations and/or arrangements of items in a box, etc.

In some embodiments, the control circuit 102 is coupled to the database 104, the plurality of human operated packing stations 108 and/or the plurality of robot operated packing station 112. By one approach, the control circuit 102 may execute one or more machine learning models to execute a first feedback loop 106. In some embodiments, the control circuit 102 may execute a first feedback loop 106 by comparing past packing configurations of a first set of item with a first (and/or current) packing configuration for the same first set of items and adjusting the first packing configuration based on this comparison. In some configurations, a machine learning model may at least in part be implemented using one or more publicly available algorithms, such as artificial neural networks, decision trees, support vector machines, regression analysis, Bayesian networks, genetic algorithms, training models, heuristic methods, deep learning, quantum bit, and/or federated learning, to name a few. In an illustrative non-limiting example of the first feedback loop 106, the control circuit 102 may access the database 104 to determine whether a first set of items, for example, a first item, a second item, a third item, and a fourth item, may be associated with a past packing configuration (e.g., whether these same combination of items had been previously packed and/or determine the one or more particular packing configurations that were used).

In some embodiments, when a past packing configuration is not available, the control circuit 102 may initially determine a hash value to associate with the first set of items. For example, weighted distributions of at least one or more item properties (e.g., physical dimensions, type of product the item belongs, health hazard, shipping requirements, perfect cuboid or not, even weight distribution of the item, etc.) associated with the first set of items may be determined by the control circuit 102. In such an example, each item property may be associated with a particular weighted value. In some configurations, the control circuit 102 may determine a weighted distribution of each item based on a sum and/or an average of the weighted values associated with the item properties of the item. In some embodiments, the control circuit 102 may determine a hash value to associate with the first set of items based on the weighted distributions of at least one or more item properties associated with the first set of items and/or a count of shipping boxes used to ship the first set of items. For example, a weighted distribution for each of the items in the first set of items is calculated, summed, and used by the control circuit 102 in the determination of the hash value. In another example, a weighted distribution of the first set of items is calculated based on aggregating item properties of each item in the first set of items and calculating the weighted distribution of the aggregated item properties, and using the calculated weighted distribution by the control circuit 102 in determining the hash value. In yet another example, the calculated weighted distribution may be added by the control circuit 102 to a count of shipping boxes used to ship the first set of items to determine the hash value. In some embodiments, the control circuit 102 may cause the database 104 to store the hash value. In some embodiments, the control circuit 102 may associate the hash value with the first set of items and/or with a count/quantity of shipping boxes used to ship the first set of items. In some configurations, the hash value is used to determine a reference count/number/quantity of shipping boxes used in part in determining a subsequent packing configuration. In such a configuration, the subsequent packing configuration is used in packing items of another purchase order including the same first set of items. Alternatively or in addition to, the count/quantity of shipping boxes used to ship the first set of items may be determined based on running a continuous iterations of a plurality of packing configurations until a packing configuration that uses a least number of shipping boxes is determined by the control circuit 102.

In some embodiments, when a past packing configuration is available, the control circuit 102 may execute the first feedback loop 106 to compare past packing configurations of the first set of item with a first (and/or current) packing configuration for the first set of items and adjust the first packing configuration based on this comparison, at step 202. In some embodiments, the control circuit 102 provides the adjusted first packing configuration to one or more of the plurality of human operated packing stations 108 for one or more humans to pack the first set of items into one or more shipping boxes in accordance with the adjusted first packing configuration, at step 204. For example, the control circuit 102 may cause the first display 122 to display and/or show the adjusted first packing configuration in order for a human to pack the first set of items in accordance with the adjusted first packing configuration shown on the first display 122. In some embodiments, the adjusted first packing configuration may be pictorially shown and/or one or more steps/instructions readably displayed on the first display 122. In some embodiments, the human operated packing stations 108 includes one or more first visual input devices 126 assigned to each of the plurality of human operated packing stations 108. In some configurations, the one or more first visual input devices 126 capture one or more images used to determine the human operator deviations from the adjusted first packing configuration. For example, a camera may capture an image depicting the human operator packing the items in a determined count of shipping boxes and/or capture the orientation and/or layout of the items in the shipping boxes. In another example, a barcode scanner may capture an electronic code (e.g., UPC code, QR code, etc.) associated with each of the shipping boxes used by the control circuit 102 to determine whether the human operator followed the count/quantity of boxes used to ship the items in accordance with the adjusted first packing configuration.

In some embodiments, the control circuit 102 executes a second feedback loop 110 to receive data from the human operated packing stations 108 including whether the human operators packed the first set of items in accordance with the adjusted first packing configuration, at step 206. In some embodiments, the control circuit 102 determines data corresponding to human operator deviations from the adjusted first packing configuration based on the data received from the human operated packing stations 108, at step 206. For example, one or more cameras and/or barcode scanners assigned to one or more human operated packing stations 108 may provide the captured data to the control circuit 102 in response to a completion of each purchase order including the first set of items. By one approach, the control circuit 102 may process the received data from the first visual input devices 126 to determine whether the human operators of the human operated packing stations 108 deviates from and/or follows the packing of the first set of items or the same set of items ordered from a plurality of purchase orders in accordance with the adjusted first packing configuration recommended by the control circuit 102 over a period of time. In some configurations, the processing of the received data may at least in part be performed using one or more publicly available digital processing techniques and/or off-the shelf software applications.

In some embodiments, based on the determination of a count of human operator deviations from the adjusted first packing configuration, the control circuit 102 may provide the adjusted first packing configuration to one or more of the plurality of human operated packing stations 108 and/or the plurality of robot operated packing stations 112 to pack additional orders of the first set of items into the one or more shipping boxes, at step 208. By one approach, the control circuit 102 may continually provide the adjusted first packing configuration to one or more of the plurality of human operated packing stations 108 based on the determination that a count of the human operator deviations from the adjusted first packing configuration over a period of time is greater than a threshold error value. In some configurations, the threshold error value is a value used by the control circuit 102 to make an autonomous decision on whether to initiate the packing of subsequent purchase orders that include the first set of items to the robot operated packing stations 112. In such a configuration, the control circuit 102 may provide the adjusted first packing configuration to one or more of the plurality of robot operated packing stations 112 based on the determination that a count of the human operator deviations from the adjusted first packing configuration over a period of time is less than a threshold error value. Thus, the control circuit 102 provides the adjusted first packing configuration to one or more robot operated packing stations 112 when the human operator deviations from the adjusted first packing configuration is less than the threshold error value indicating that the adjusted first packing configuration leads to a desired packing efficiency level and/or the most efficient packing configuration to pack the first set of items. As such, a count of human operator deviations that is less than a threshold error value indicates a high confidence that the corresponding packing configuration meets a desired packing efficiency level of and/or provides the most efficient packing configuration to pack the corresponding set of items and/or that the first set of items is a candidate for packing in the robot operated packing stations 112. As such, in an illustrative non-limiting example, if the threshold error value is equal to 0.20 and a count of human operator deviations corresponds to an error rate that is 0.10 (e.g., humans who deviated used an average of 2.1 boxes while the remaining humans who followed the recommended packaging configuration used an average of 2.0 boxes over a period of time), the control circuit 102 may determine that the packing configuration for the corresponding set of items has a confidence level of 0.9 (e.g., confidence level=1−error rate), which is better than the threshold confidence level of 0.80 (e.g., threshold confidence level=1−threshold error value) that is used as a reference level for the control circuit 102 to determine that a particular packing configuration for a set of items is a candidate for packing in the robot operated packing stations 112. In some embodiments, a count of human operator deviations that is less than a threshold error value indicates that the corresponding packing configuration has a high likelihood/confidence that the corresponding packing configuration meets a desired packing efficiency level of and/or provides the most efficient packing configuration to pack the corresponding set of items and/or that the corresponding set of items is a candidate for packing in the robot operated packing stations 112.

In some embodiments, in comparing the past packing configurations with a first (and/or current) packing configuration, the control circuit 102 may determine a first count of shipping boxes associated with a previous hash value associated with the first set of items. In some embodiments, the control circuit 102 may continuously run iterations until a determination of a first packing configuration that uses less or the same count of shipping boxes as the count of shipping boxes that is associated with the previous hash value. As such, a first set of items that were previously packed may have an associated hash value stored in the database 104. In some embodiments, the control circuit 102 may use the count of shipping boxes associated with the stored hash value associated with the first set of items as an initial number of shipping boxes to use during an execution of the first feedback loop 106 to determine a packing configuration for items in a subsequent purchase order that also include the same first set of items. In some embodiments, the subsequent purchase order may only include the same first set of items and/or also include one or more additional items that were not included in the first set of items. Thus, the calculations, storage, and/or use of hash value in determining a packing configuration used to pack and ship items in a purchase order enables the control circuit 102 to quickly determine the number of shipping boxes to use in packing the items and/or the orientation and/or layout of the items in the determined number of shipping boxes. In some embodiments, over time, the control circuit 102 may determine which one or more set of items are candidates for assigning to the robot operated packing stations 112 to pack and ship based on a cluster of hash values that have hash values that are relatively close to one another, such as a fraction and/or a single digit difference from one hash value to another hash value. In some embodiments, in response to a determination that a particular set of items is one of the candidates for assigning to the robot operated packing stations 112 to pack and ship, the control circuit 102 may provide the corresponding packing configuration to the station control circuit 116 in order for the station control circuit 116 to cooperatively work with the electro-mechanical driven components the robot operated packing station 112 take items on the second conveyor 118 and pack these items in one or more shipping boxes in accordance with the received corresponding packing configuration without assistance from a human. In some embodiments, the one or more second visual input devices 120 of the robot operated packing station 112 may capture images of the items prior to sealing of the shipping boxes. In some configuration, the station control circuit 116 may use the captured images as a confirmation that the items were packed in accordance with the received corresponding packing configuration.

In some embodiments, each purchase order is associated with a hash value generated by the control circuit 102 based at least on one or more of properties of items in the purchase order and how the items were shipped, to name a few. In some embodiments, the hash number particularly identifies the purchase order in a three-dimensional (3D) space and/or matrix that are stored in the database 104. In some embodiments, for each purchase order received by a retail store, the control circuit 102 generates a corresponding hash value and stores the corresponding hash value to the 3D space and/or matrix of the database 104. In some embodiments, the control circuit 102 uses the closest hash value to a current purchase order as a reference to determine an initial count/quantity of boxes to use in running the iterations in the first feedback loop 106 to determine a packing configuration to recommend in packing the items in the current purchase order. In an illustrative non-limiting example, there are 5 purchase orders stored in the database 104 that have hash values 21.23, 21.45, 21.5, 21.68, and 20.98, respectively. In some embodiments, the hash values 21.23, 21.45, 21.5, 21.68, and 20.98 are in a particular cluster in the 3D matrix/space. Each of these purchase orders and/or hash values in this particular cluster is associated with using 2 shipping boxes. As such, the database 104 and/or the 3D matrix/space includes a plurality of clusters, where each cluster is associated with a plurality of previous purchase orders and/or a plurality of sets of items. Continuing this illustrative non-limiting example, the control circuit 102 determines or generates for the current purchase order a hash value of 21.75. In some embodiments, the control circuit 102 accesses the database 104 to determine a closest purchase order and/or cluster stored in the database 104 to find a count/quantity of boxes to use as a reference count/quantity of boxes used in running iterations in the first feedback loop 106 to determine a packing configuration to recommend in packing the items in the current purchase order. In response to determining the reference count/quantity of boxes, the control circuit 102 runs iterations until a packing configuration is determined that uses the same number of count/quantity of boxes as the reference. In some embodiments, the reference count/quantity of boxes may be used by the control circuit 102 as an optimization parameter along with a generated hash value to determine the most efficient packing configuration to pack a set of items, thereby reducing the cost associated with shipping purchased items.

In some embodiments, in response to a determination that the human operator deviations from the adjusted first packing configuration is at least a threshold error value at step 302, the control circuit 102 determines whether a first count of shipping boxes used to ship the first set of items in accordance with the human operator deviations is less than a second count of shipping boxes in accordance with the adjusted first packing configuration, at step 304. In some embodiments, in response to the determination that the first count of shipping boxes used to ship the first set of items in accordance with the human operator deviations is less than the second count of shipping boxes in accordance with the adjusted first packing configuration, the control circuit 102 may increase a number of iterations ran to determine a subsequent packing configuration relative to a previous number of iterations that were ran to determine the adjusted first packing configuration, at step 312. For example, in a scenario where the control circuit 102 determines that the average number of boxes used by human operators that deviated from the packing configuration as recommended by the control circuit 102 is less than the average number of boxes used by human operators that followed the packing configuration, the control circuit 102 may increase the number of iterations ran to determine a subsequent packing configuration relative to a previous number of iterations that were previously ran to determine the packing configuration.

In some embodiments, in response to a determination that the human operator deviations from an adjusted first packing configuration is at least a threshold error value at step 302, the control circuit 102 may determine a difference between a first average count of shipping boxes used to ship the first set of items in accordance with the human operator deviations over a period of time and a second count of shipping boxes in accordance with the adjusted first packing configuration over the same period of time, at step 306. In some embodiments, the control circuit 102 may compare the determined difference with a target error rate to determine the number of iterations to run in determining a subsequent packing configuration recommended by the control circuit 102. In some embodiments, a target error rate allows a user to control a number of iterations ran in determining a subsequent packing configuration in the first feedback loop 106. In some embodiments, the target error rate may be an interaction tool used by an associate in the retail facility to fine-tune the system 100 and/or the control circuit 102 in providing a desired packing efficiency level and/or the most efficient packing configuration to pack the first set of items. In some configurations, in response to the determination that the difference is less than the target error rate, the control circuit 102 may increase the number of iterations ran to determine the subsequent packing configuration relative to a previous number of iterations ran that determined the adjusted first packing configuration, at step 312. Illustrative non-limiting examples are shown in Examples 1, 2, 3, and 6 of Table 1 below. The difference between a first average count of shipping boxes used to ship the first set of items in accordance with the human operator deviations and a second count of shipping boxes in accordance with the adjusted first packing configuration corresponds to the error rate shown in Table 1.

In some embodiments, in response to a determination that the human operator deviations from the adjusted first packing configuration is at least a threshold error value at step 302, the control circuit 102 may determine a difference between a first average count of shipping boxes used to ship the first set of items in accordance with the human operator deviations over a period of time and a second count of shipping boxes in accordance with the adjusted first packing configuration over the period of time, at step 308. In some embodiments, in response to the determination that the difference is greater than a target error rate, the control circuit 102 provides an alert message to an electronic device 114 associated with a retail facility, at step 314. In such an embodiment, the alert message indicates that there is a high likelihood that an overall packaging of the first set of items in the retail facility is inefficient and/or that there is an anomaly in packaging the set of items (e.g., one or more items in the set of items have irregular shape, too big, restrictive shipping requirements, an item may just be inefficient to ship, etc.). Illustrative non-limiting examples are shown in Examples 4, 7, 8, and 9 of Table 1.

In some embodiments, based on the alert message, an associate associated with the electronic device 114 may identify the cause of the inefficiency or anomaly and determine if there is valid justification for the inefficiency or anomaly. In response to the determination of valid justification, the control circuit 102 may be configured to ignore the alert for a predetermined period of time by not sending or providing the alert message to the electronic device 114. Alternatively or in addition to, the associate may manually modify an interaction tool by increasing the target error rate to tighten the slack or inefficiencies created in the system 100. Alternatively or in addition to, the associate may identify one or more human operated packing stations 108 that cause the inefficiency or anomaly and isolate them so that the rest of the human operated packing stations 108 can operate at full and/or desired efficiency. Alternatively or in addition to, the associate may cause the control circuit 102 to provide a log and/or report including a history of recommended packing configurations and/or captured images/data from the first visual input devices 126 to determine a cause of the inefficiency or anomaly. In response, the associate may provide one or more user input to the control circuit 102 via the electronic device 114 including assignment of correct box sizes and/or categorization for those items that are contributing to the inefficiency or anomaly.

In some embodiments, in response to a determination that the human operator deviations from the adjusted first packing configuration is at least a threshold error value at 302, the control circuit 102 determines a difference between a first average count of shipping boxes used to ship the first set of items in accordance with the human operator deviations over a period of time and a second count of shipping boxes in accordance with the adjusted first packing configuration over the period of time, at step 308. In some embodiments, in response to the determination that the difference is greater than a target error rate, the control circuit 102 decreases (or reduce) the number of iterations ran to determine the subsequent packing configuration relative to a previous number of iterations ran determining the adjusted first packing configuration, at step 316. Illustrative non-limiting examples are shown in Examples 4, 7, 8, and 9 of Table 1.

In some embodiments, in response to a determination that the human operator deviations from the adjusted first packing configuration is at least a threshold error value at step 302, the control circuit 102 determines a difference between a first average count of shipping boxes used to ship the first set of items in accordance with the human operator deviations over a period of time and a second count of shipping boxes in accordance with the adjusted first packing configuration over the period of time, at step 310. In some embodiments, in response to the determination that the difference is equal to or greater than a target error rate, the control circuit 102 determines the subsequent packing configuration by running the same number of iterations as used in determining the adjusted first packing configuration, at step 318. Illustrative non-limiting examples for the difference being equal to are shown in Examples 5 and 10 of Table 1. Illustrative non-limiting examples for the difference being greater than are shown in Examples 4, 7, 8, and 9 of Table 1.

Table 1 below shows a number of illustrative non-limiting examples of automatically determining packing configurations for packing items into shipping boxes in accordance with some embodiments. One or more examples listed in Table 1 may be implemented in the system 100 of FIG. 1, method 200 of FIG. 2, and/or method 300 of FIG. 3.

TABLE 1

| | |
|---|---|
| Example 1 | If target error rate = 0.3 and error rate is 0.1, run more iterations to increase error |
| | rate -forcing more humans to use more boxes than as recommended by the |
| | packing configuration. |
| Example 2 | If target error rate = 0.3 and error rate is −0.1, run more iterations to increase error |
| | rate -forcing more humans to use more boxes than as recommended by the |
| | packing configuration. |
| Example 3 | If target error rate = 0.3 and error rate is 0, run more iterations to increase error |
| | rate - forcing more humans to use more boxes than as recommended by the |
| | packing configuration. |
| Example 4 | If target error rate = 0.3 and error rate is 0.4, stop running more iterations and/or |
| | reduce iterations and may inform retail facility manager of overall decrease in |
| | efficiency. |
| Example 5 | If target error rate = 0.3 and error rate is 0.3, no action and/or also inform retail |
| | facility manager of overall decrease in efficiency. |
| Example 6 | If target error rate = −0.3 and error rate is −0.4, run more iterations to increase |
| | error rate -forcing more humans to use more boxes than as recommended by the |
| | packing configuration. |
| Example 7 | If target error rate = −0.3 and error rate is 0, stop running more iterations and/or |
| | reduce iterations and may inform retail facility manager of overall decrease in |
| | efficiency. |
| Example 8 | If target error rate = −0.3 and error rate is 0.1, stop running more iterations and/or |
| | reduce iterations and may inform retail facility manager of overall decrease in |
| | efficiency. |
| Example 9 | If target error rate = −0.3 and error rate is −0.2, stop running more iterations and/or |
| | reduce iterations and may inform retail facility manager of overall decrease in |
| | efficiency. |
| Example 10 | If target error rate = −0.3 and error rate is −0.3, no action and/or also inform retail |
| | facility manager of overall decrease in efficiency. |

In some embodiments, the second feedback loop 110 may include the control circuit 102 determining whether a majority of humans follow the packing configuration as recommended (or shown/displayed on the first display 122) by the control circuit 102. By one approach, if the majority follow the recommended packing configuration, the control circuit 102 may not take additional actions (e.g., increase and/or decrease iterations ran in the first feedback loop 106 and/or consider a modification of the target error rate unless a signal is received that instructs the control circuit 102 to consider or receive the modification as a user input). By another approach, if the majority deviates from the recommended packing configuration, the second feedback loop 110 may include the control circuit 102 determining whether the count/quantity of boxes used that deviated from the recommended packing configuration is less than those count/quantity of boxes used by following the recommended packing configuration. In some embodiments, in response to a determination that the count/quantity of boxes used that deviated from the recommended packing configuration is less than those count/quantity of boxes used by following the recommended packing configuration, the control circuit 102 may conform and/or configure a subsequent packing configuration to use the same count/quantity of boxes used as those used that deviated from the recommended packing configuration. In some embodiments, in response to a determination that the count/quantity of boxes used that deviated from the recommended packing configuration is equal to and/or greater than those count/quantity of boxes used by following the recommended packing configuration, the control circuit 102 may provide an alert message to an associate in a retail facility (e.g., a manager, a supervisor, an employee in management, etc.) indicating a possible overall decline in efficiency in packing corresponding set of items.

In some embodiments, alternatively or in addition to determining whether the count/quantity of boxes used that deviated from the recommended packing configuration is less than those count/quantity of boxes used by following the recommended packing configuration, the control circuit 102 may determine a confidence level and/or error rate associated with a packing configuration. In some configuration, the determination of the confidence level may be based on an average of confidence levels and/or error rates determined at least in part by comparing the count/quantity of boxes used that deviated from the recommended packing configuration with those counts/quantities of boxes used by following the recommended packing configuration.

In some embodiments, the control circuit 102 may compare the determined error rate with the target error rate to adjust and/or fine-tune the subsequent packing configuration in order to provide a desired packing efficiency level and/or the most efficient packing configuration to pack a set of items. In an illustrative non-limiting example, Table 1 provides illustrative examples of the control circuit 102 adjusting and/or fine-tuning a packing configuration that is subsequently recommended and/or provided by the control circuit 102 to one or more human operated packing stations 108 assigned to pack the corresponding set of items. In some embodiments, the control circuit 102 may adjust a threshold confidence level and/or a threshold error value up or down in order to provide a desired packing efficiency level and/or the most efficient packing configuration to pack a set of items. In some embodiments, to improve efficiency, the control circuit 102 may provide or recommend a packing configuration that uses less boxes relative to a previously recommend/provided packing configuration by running more iterations in the first feedback loop 106. In some embodiments, to decrease/reduce efficiency, the control circuit 102 may provide or recommend a packing configuration that uses more boxes relative to a previously recommend/provided packing configuration by selecting a packing configuration from a history of simulated or previously iterated packing configurations that was less efficient/lenient version of the previously recommend/provided packing configuration (e.g., a version with a count/quantity of boxes that are greater than the count/quantity of boxes used in the previously recommend/provided packing configuration), or by selecting a packing configuration used by a human that deviated from the previously recommend/provided packing configuration via one or more images captured by the first visual input devices 126.

In some embodiments, by using one or more machine learning models, the control circuit 102 may automatically determine the most efficient packing configurations as described herein for each set of items without having to store a listing of business rules particular to each product and/or item. By implementing the first feedback loop 106 and the second feedback loop 110 cooperatively, the control circuit 102 self-corrects and quickly adapts without a need for human intervention whenever a better packing configuration is determined by the control circuit 102 in a subsequent iterations and/or by a human who decided to deviate from the recommended packing configuration. The system 100 as described herein may provide a relatively efficient method of flagging items that are generally problematic to ship because of some anomaly as described herein. In some embodiments, the control circuit 102 may store and flag items that are identified as problematic due to an identified anomaly in order for the control circuit 102 to quickly identify these items in purchase orders. In response, the control circuit 102 may automatically separate these items and assign these items for a separate fulfillment to improve the overall fill rate of a large number of purchase orders. In some embodiments, the control circuit 102 may automatically identify these items as items warranting additional shipping costs.

In some embodiments, the target error rate provides a retail facility manager ability to steer the overall efficiency of the system 100. For example, the retail facility manager modifies (e.g., increase or decrease) the target error rate to adjust the overall efficiency of the system 100 to a desired level of efficiency. In some embodiments, when the target error rate is set higher relative to a previous target error rate, the control circuit 102 increases the number of iterations and tries to fit more items in the same number of box(es) as in previously recommended packing configuration. Thus, a too high of a target error rate would result in an increased deviation by a human and/or an associate associated with a human operated packing station 108 from an adjusted first packing configuration and/or a recommended packing configuration provided by the control circuit 102. As such, an associated confidence level of the adjusted first packing configuration and/or the recommended packing configuration may be lower than a threshold confidence level over a time period that the target error rate is set to the too high of a target error rate. In other words, the associated error rate may be greater than a threshold error value over the same time period that the target error rate is set to the too high of a target error rate. In such an embodiment, the retail facility manager (and/or other associate of a retail store) adjusts and/or modifies the target error rate over time to determine a packing configuration that provides a particular confidence level within a threshold confidence level over a time period (e.g., a range of predetermined values below and/or at the threshold confidence level and/or above and/or at the threshold confidence level).

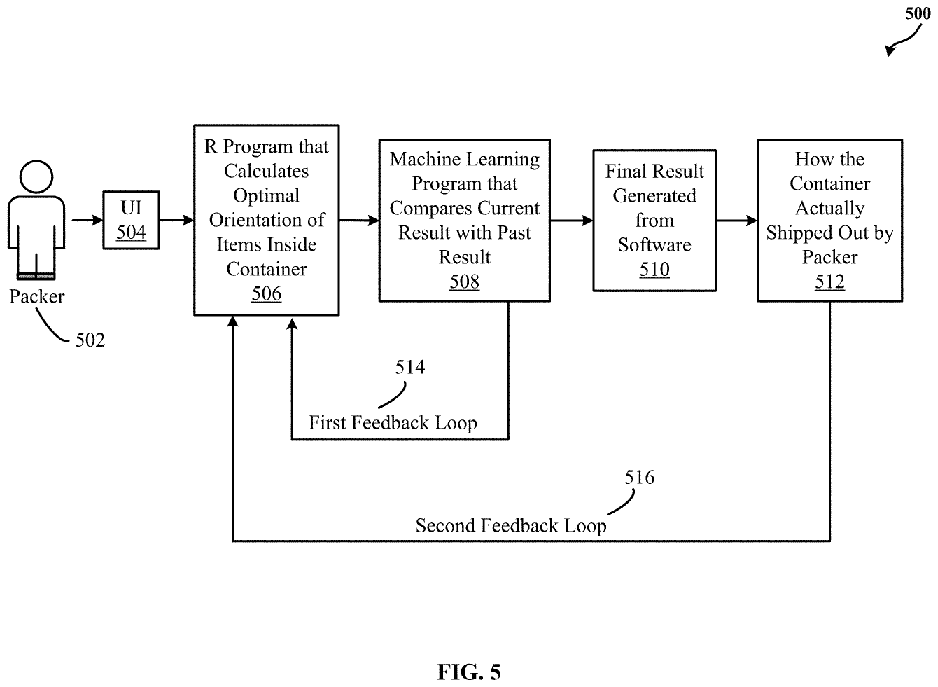

In another illustrative non-limiting examples, FIGS. 5-7 show flow diagrams of exemplary processes (or methods) 500, 600, and 700 of automatically determining packing configurations for packing items into shipping boxes in accordance with some embodiments. One or more of the methods 500, 600, and 700 may be implemented in the system 100 of FIG. 1. By one approach, one or more steps (or blocks) of one or more of the methods 500, 600, and 700 may be implemented with one or more steps of one or more methods 200 and 300 of FIGS. 2 and 3, respectively. In some embodiments, as depicted in FIG. 5, a packer 502 initiates packing of one or more items associated with a purchase order via a user interface (UI) 504. By one approach, the UI 504 may be operated on one or more electronic devices 114 associated with each packer associated with one or more of the human operated packing stations 108. In some embodiments, the UI 504 is coupled to the control circuit 102. In some embodiments, initiation of the UI 504 causes the control circuit 102 to execute an R program that calculates an optimal orientation of one or more items inside a container (e.g., a shipping box) relative to previously calculated orientations (performed at a current time period) of the one or more items inside the container, at step 506. In some embodiments, the control circuit 102 executes, at step 508, a machine learning program that compares a current result of the calculated optimal orientation of the one or more items with one or more past (or previous) optimal orientations that were calculated at a previous time period. In some embodiments, in response to a determination that the past optimal orientation is better than the current calculated optimal orientation (e.g., the past optimal orientation yields less count/quantity of shipping boxes used to pack and/or ship at least the same items), the control circuit 102 re-executes the R program that calculates another optimal orientation in the first feedback loop 514. Thus, in some embodiments, the first feedback loop 514 includes steps 506 and 508. By one approach, the R program may include an R programming language and/or any programming language for statistical computing and graphics software program/applications. In some embodiments, in response to a determination that the current calculated optimal orientation is better than the past optimal orientation, the control circuit 102 in cooperation of the R program generates a final resulting packing configuration to recommend to the packer 502, at step 510. In some embodiments, the packing configuration may be shown on one or more first displays 122 in order for the packer 502 to visually see and/or readably read the instructions to orient the one or more items. In some embodiments, one or more first visual input devices 126 may provide data to the control circuit 102 during a second feedback loop 516. By one approach, the data may include information on how the one or more items are packed in the container and/or shipped out by the packer 502. In some embodiments, the control circuit 102 may use the data received in the second feedback loop 516 in performing step 506 and/or step 508 in the first feedback loop 514. In some embodiments, the first feedback loop 514 and/or the second feedback loop 516 may correspond to the first feedback loop 106 and/or the second feedback loop 110 of FIG. 1 or the first feedback loop and/or the second feedback loop in the method 200 and/or the method 300.

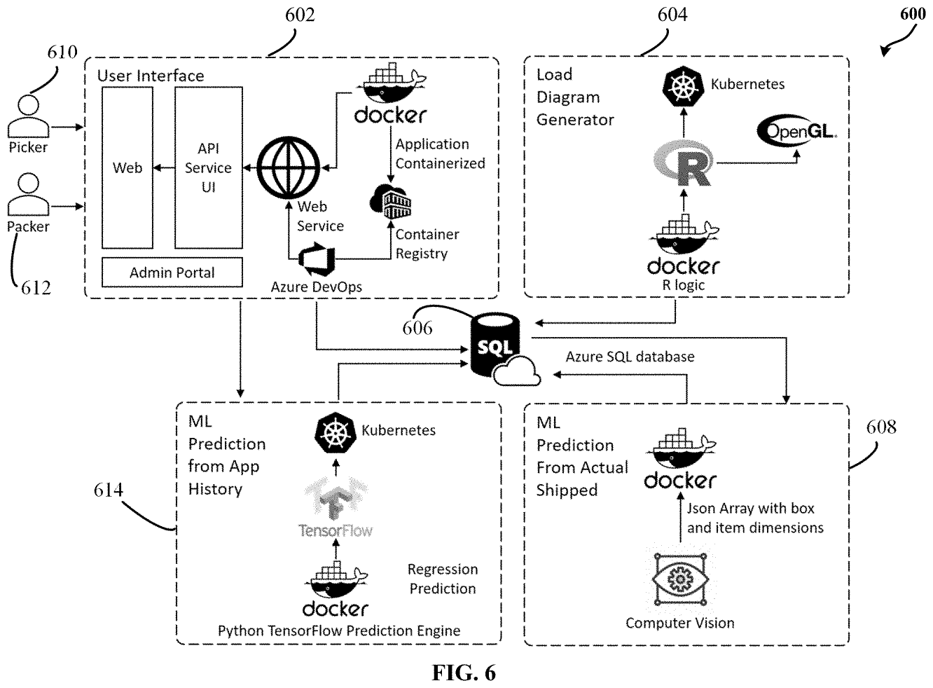

In some embodiments, both picker 610 (e.g., one or more associates that pick items included in a purchase order) and packer 612 (e.g., one or more associates that pack the items picked by the picker 610) may each use an electronic device 114. In an illustrative non-limiting example, the UI 504 of FIG. 5 operable on each of the electronic device 114 may include one or more components of a user interface (UI) 602 block shown in FIG. 6. In some embodiments, the step 506 of FIG. 5 may include one or more components of a load diagram generator block 604 shown in FIG. 6. In some embodiments, the first feedback loop 514, the step 506, the step 508, and/or the step 510 of FIG. 5 may include one or more components of an ML prediction from App History block 614 shown in FIG. 6. In some embodiments, the second feedback loop 516, the step 506 and/or the step 512 of FIG. 5 may include one or more components of an ML prediction from Actual Shipped block 608 shown in FIG. 6. By one approach, the database 104 of FIG. 1 may correspond to an SQL database 606 of FIG. 6.

In some embodiments, the method 700 shows sequence and/or timing diagram illustrating one or more executed instructions and/or modules resulting in a recommended packing configuration shown in at least one first display 122 associated with a human operated packing station 108. In some embodiments, a UserInterface module 702 may correspond to the UI 504 and/or the UI block 602. In some embodiments, an ImageModeller module 704 may correspond to the load diagram generator block 604 and/or the step 506. In some embodiments, an MLwithAppData module 706 may correspond to the ML prediction from App History block 614 and/or the step 508. In some embodiments, an MLwithShipData module 708 may correspond to the ML prediction from Actual Shipped block 608 and/or the step 512. In some embodiments, a database 710 may correspond to the database 104 and/or the SQL database 606. In some embodiments, the control circuit 102 may execute an InsightsReport module 712 to provide alerts, inefficiencies and/or anomalies described herein.

In some embodiments, the UserInterface module 702 provides a requestCartonization data signal to the ImageModeller module 704. By one approach, the ImageModeller module 704 causes a number of packing configurations to be ran to determine a packing configuration with the least number of shipping boxes used in packing and/or shipping one or more items of a purchase order. In an illustrative non-limiting example, a determined packing configuration may include two shipping boxes where each box is associated with a particular set of items in the purchase order, and the particular set of items are oriented and/or arranged in a particular way to enable the fulfillment of the purchase order with using two shipping boxes. In another illustrative non-limiting example, the ImageModeller module 704 may initially generate a packing configuration using one shipping box to accommodate items in a purchase order. In such an example, when after a number of iterations the ImageModeller module 704 is unable to provide a configuration using one box, the control circuit 102 may cause the ImageModeller module 704 to start running the subsequent iterations using an additional shipping boxes until a packing configuration is determined that accommodates all items in the purchase order.

In some embodiments, the ImageModeller module 704 provides a requestBoxCount data signal to the MLwithAppData module 706. By one approach, the MLwithAppData module 706 provides an EstimatedBoxCount data signal including a reference count/number/quantity of shipping boxes used in part in determining a packing configuration. In response, the ImageModeller module 704 run a number of iterations to determine a packing configuration that accommodates the items in a purchase order using the reference count/number/quantity of shipping boxes provided by the MLwithAppData module 706. In some embodiments, the ImageModeller module 704 provides a requestErrorIndex data signal to the MLwithShipData module 708. In some configurations, the MLwithShipData module 708 may access the database 710 to determine packing configurations that deviated from recommended packing configuration for the same items from previous orders. In some embodiments, the MLwithShipData module 708 provides an EstimatedErrorIndex data signal to the ImageModeller module 704. By one approach, the EstimatedErrorIndex data signal may include corresponding confidence level, error rate, and/or target error rate associated with the same set of items. In some embodiments, the ImageModeller module 704 generates a recommended packing configuration based at least in part on the EstimatedErrorIndex data signal. In some embodiments, the ImageModeller module 704 provides a 3DLoadDiagram data signal to the UserInterface module 702 to cause the UserInterface module 702 to display the recommended packing configuration. In some embodiments, the 3DLoadDiagram data signal includes the recommended packing configuration. In some embodiments, the ImageModeller module 704 provides a boxCountwithOrderData data signal to the database 710. In some embodiments, the boxCountwithOrderData data signal includes the corresponding purchase order and/or items and the count/quantity of shipping boxes used to pack and ship the items. In some embodiments, the MLwithShipData module 708 provides an errorIndexwithOrderData data signal to the database 710. In some embodiments, the errorIndexwithOrderData data signal includes one or more packing configuration that deviated from the recommended packing configuration associated with the 3DLoadDiagram data signal provided to the UserInterface module 702 by the ImageModeller module 704. In some embodiments, the ImageModeller module 704 provides a jsonPackingInstructions data signal to the database 710. In some embodiments, the jsonPackingInstructions data signal includes the recommended packing configuration associated with the 3DLoadDiagram data signal. In some embodiments, the jsonPackingInstructions data signal includes written instructions to pack items in accordance with the 3DLoadDiagram data signal. In some embodiments, the control circuit 102 may access the database 710 and determine one or more items in the purchase order that caused one or more packers to deviate from the recommended packing configuration associated with the 3DLoadDiagram data signal. In response, the one or more items that caused deviation from the recommended packing configuration are flagged and the corresponding UPC codes stored in the database 710. In some embodiments, the control circuit 102 provides a FlaggedUPCs data signal to the InsightsReport module 712. In some embodiments, the InsightsReport module 712 generates one or more reports to one or more associates in the retail facility alerting the one or more associates to set aside the flagged items for special handling, packing, and/or shipping instructions. In some embodiments, the control circuit 102 may cooperate with the InsightsReport module 712 to identify flagged items in a purchase order and provide a recommended packaging configuration based at least in part to the identified flagged items.

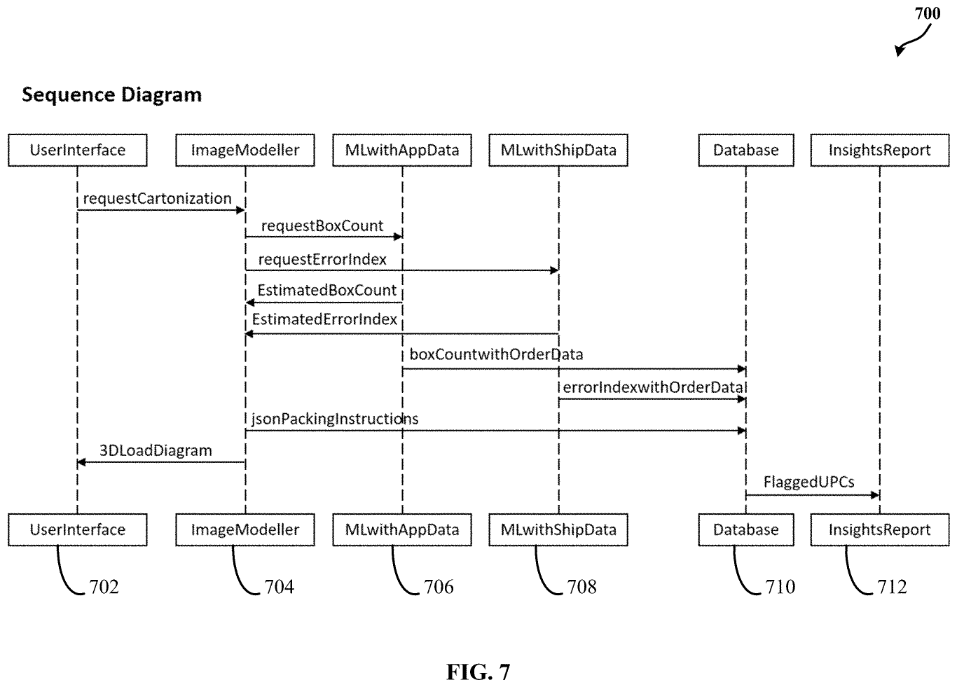

Further, the circuits, circuitry, systems, devices, processes, methods, techniques, functionality, services, servers, sources and the like described herein may be utilized, implemented and/or run on many different types of devices and/or systems. FIG. 4 illustrates an exemplary system 400 that may be used for implementing any of the components, circuits, circuitry, systems, functionality, apparatuses, processes, or devices of the system 100 of FIG. 1, the method 200 of FIG. 2, the method 300 of FIG. 3, the method 500 of FIG. 5, the method 600 of FIG. 6, the method 700 of FIG. 7, and/or other above or below mentioned systems or devices, or parts of such circuits, circuitry, functionality, systems, apparatuses, processes, or devices. For example, the system 400 may be used to implement some or all of the system 100 for automatically determining packing configurations for packing items into shipping boxes at a retail facility, the control circuit 102, the station control circuit 116, the robot operated packing stations 112, the second conveyors 118, the second visual input devices 120, the human operated packing stations 108, the first displays 122, the first conveyors 124, the first visual input devices 126, the database 104, the electronic devices 114, and/or other such components, circuitry, functionality and/or devices. However, the use of the system 400 or any portion thereof is certainly not required.

By way of example, the system 400 may comprise a processor module (or a control circuit) 412, memory 414, and one or more communication links, paths, buses or the like 418. Some embodiments may include one or more user interfaces 416, and/or one or more internal and/or external power sources or supplies 440. The control circuit 412 can be implemented through one or more processors, microprocessors, central processing unit, logic, local digital storage, firmware, software, and/or other control hardware and/or software, and may be used to execute or assist in executing the steps of the processes, methods, functionality and techniques described herein, and control various communications, decisions, programs, content, listings, services, interfaces, logging, reporting, etc. Further, in some embodiments, the control circuit 412 can be part of control circuitry and/or a control system 410, which may be implemented through one or more processors with access to one or more memory 414 that can store instructions, code and the like that is implemented by the control circuit and/or processors to implement intended functionality. In some applications, the control circuit and/or memory may be distributed over a communications network (e.g., LAN, WAN, Internet) providing distributed and/or redundant processing and functionality. Again, the system 400 may be used to implement one or more of the above or below, or parts of, components, circuits, systems, processes and the like. For example, the system 400 may implement the system for automatically determining packing configurations for packing items into shipping boxes at a retail facility (e.g., a fulfillment center, a retail store, a distribution center, etc.) with the control circuit 102 being the control circuit 412.

The user interface 416 can allow a user to interact with the system 400 and receive information through the system. In some instances, the user interface 416 includes a display 422 and/or one or more user inputs 424, such as buttons, touch screen, track ball, keyboard, mouse, etc., which can be part of or wired or wirelessly coupled with the system 400. Typically, the system 400 further includes one or more communication interfaces, ports, transceivers 420 and the like allowing the system 400 to communicate over a communication bus, a distributed computer and/or communication network (e.g., a local area network (LAN), the Internet, wide area network (WAN), etc.), communication link 418, other networks or communication channels with other devices and/or other such communications or combination of two or more of such communication methods. Further the transceiver 420 can be configured for wired, wireless, optical, fiber optical cable, satellite, or other such communication configurations or combinations of two or more of such communications. Some embodiments include one or more input/output (I/O) interface 434 that allow one or more devices to couple with the system 400. The I/O interface can be substantially any relevant port or combinations of ports, such as but not limited to USB, Ethernet, or other such ports. The I/O interface 434 can be configured to allow wired and/or wireless communication coupling to external components. For example, the I/O interface can provide wired communication and/or wireless communication (e.g., Wi-Fi, Bluetooth, cellular, RF, and/or other such wireless communication), and in some instances may include any known wired and/or wireless interfacing device, circuit and/or connecting device, such as but not limited to one or more transmitters, receivers, transceivers, or combination of two or more of such devices.

In some embodiments, the system may include one or more sensors 426 to provide information to the system and/or sensor information that is communicated to another component, such as the control circuit 102, the station control circuit 116, the robot operated packing stations 112, the second conveyors 118, the second visual input devices 120, the human operated packing stations 108, the first conveyors 124, the first visual input devices 126, the database 104, the electronic devices 114, etc. The sensors can include substantially any relevant sensor, such as temperature sensors, distance measurement sensors (e.g., optical units, sound/ultrasound units, etc.), optical based scanning sensors to sense and read optical patterns (e.g., bar codes), radio frequency identification (RFID) tag reader sensors capable of reading RFID tags in proximity to the sensor, and other such sensors. The foregoing examples are intended to be illustrative and are not intended to convey an exhaustive listing of all possible sensors. Instead, it will be understood that these teachings will accommodate sensing any of a wide variety of circumstances in a given application setting.

The system 400 comprises an example of a control and/or processor-based system with the control circuit 412. Again, the control circuit 412 can be implemented through one or more processors, controllers, central processing units, logic, software and the like. Further, in some implementations the control circuit 412 may provide multiprocessor functionality.

The memory 414, which can be accessed by the control circuit 412, typically includes one or more processor readable and/or computer readable media accessed by at least the control circuit 412, and can include volatile and/or nonvolatile media, such as RAM, ROM, EEPROM, flash memory and/or other memory technology. Further, the memory 414 is shown as internal to the control system 410; however, the memory 414 can be internal, external or a combination of internal and external memory. Similarly, some or all of the memory 414 can be internal, external or a combination of internal and external memory of the control circuit 412. The external memory can be substantially any relevant memory such as, but not limited to, solid-state storage devices or drives, hard drive, one or more of universal serial bus (USB) stick or drive, flash memory secure digital (SD) card, other memory cards, and other such memory or combinations of two or more of such memory, and some or all of the memory may be distributed at multiple locations over the computer network. The memory 414 can store code, software, executables, scripts, data, content, lists, programming, programs, log or history data, user information, customer information, product information, and the like. While FIG. 4 illustrates the various components being coupled together via a bus, it is understood that the various components may actually be coupled to the control circuit and/or one or more other components directly.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

What is claimed is:

1. A system for automatically determining packing configurations for packing items into shipping boxes at a retail facility, the system comprising:
a plurality of human operated packing stations;
a plurality of robot operated packing stations;
a database storing item data, shipping box data, and packing configuration data including packing configurations for packing combinations of items into shipping boxes; and
a control circuit coupled to the database, the plurality of human operated packing stations and the plurality of robot operated packing stations, wherein the control circuit is configured to execute one or more machine learning models to:
execute a first feedback loop to compare past packing configurations of a first set of item with a first packing configuration for the first set of items and adjust the first packing configuration based on this comparison;
provide the adjusted first packing configuration to one or more of the plurality of human operated packing stations for a human to pack the first set of items into one or more shipping boxes in accordance with the adjusted first packing configuration;
execute a second feedback loop to receive data from the plurality of human operated packing stations comprising whether human operators packed the first set of items in accordance with the adjusted first packing configuration; and determine data corresponding to human operator deviations from the adjusted first packing configuration based on the data received from the plurality of human operated packing stations; and
provide the adjusted first packing configuration to one or more of the plurality of human operated packing stations and the plurality of robot operated packing stations to pack additional orders of the first set of items into the one or more shipping boxes.

2. The system of claim 1, wherein the control circuit is further configured to:
determine a hash value to associate with the first set of items based on weighted distributions of at least one or more item properties associated with the first set of items and a count of shipping boxes used to ship the first set of items; and
cause the database to store the hash value and associate the hash value with the first set of items and a count of the one or more shipping boxes associated with the adjusted first packing configuration, wherein the hash value is used to determine a reference count of shipping boxes used in part in determining a subsequent adjusted first packing configuration.

3. The system of claim 2, wherein, in comparing the past packing configurations with the first packing configuration, the control circuit is further configured to:
determine a first count of shipping boxes associated with a previous hash value associated with the first set of items; and
continuously run iterations until a determination of the first packing configuration that uses the same count or less of shipping boxes as the first count of shipping boxes.

4. The system of claim 1, wherein the control circuit is further configured to provide the adjusted first packing configuration to the plurality of robot operated packing stations when the human operator deviations from the adjusted first packing configuration is less than a threshold error value.

5. The system of claim 1, further comprising one or more visual input devices assigned to each of the plurality of human operated packing stations, the one or more visual input devices configured to capture one or more images used to determine the human operator deviations from the adjusted first packing configuration.

6. The system of claim 1, wherein, in response to a determination that the human operator deviations from the adjusted first packing configuration is at least a threshold error value, the control circuit is further configured to:
determine whether a count of shipping boxes used to ship the first set of items in accordance with the human operator deviations is less than a first count of shipping boxes in accordance with the adjusted first packing configuration; and
in response to the determination that the count of shipping boxes used to ship the first set of items in accordance with the human operator deviations is less than the first count of shipping boxes, increase a number of iterations ran to determine a subsequent packing configuration relative to a previous number of iterations ran determining the adjusted first packing configuration.

7. The system of claim 1, wherein, in response to a determination that the human operator deviations from the adjusted first packing configuration is at least a threshold error value, the control circuit is further configured to:
determine a difference between a first average count of shipping boxes used to ship the first set of items in accordance with the human operator deviations over a period of time and a second count of shipping boxes in accordance with the adjusted first packing configuration over the period of time, wherein a target error rate allows a user to control a number of iterations ran in determining a subsequent packing configuration in the first feedback loop; and
in response to the determination that the difference is less than the target error rate, increase the number of iterations ran to determine the subsequent packing configuration relative to a previous number of iterations ran determining the adjusted first packing configuration.

8. The system of claim 1, wherein, in response to a determination that the human operator deviations from the adjusted first packing configuration is at least a threshold error value, the control circuit is further configured to:
determine a difference between a first average count of shipping boxes used to ship the first set of items in accordance with the human operator deviations over a period of time and a second count of shipping boxes in accordance with the adjusted first packing configuration over the period of time, wherein a target error rate allows a user to control a number of iterations ran in determining a subsequent packing configuration in the first feedback loop; and
in response to the determination that the difference is greater than the target error rate, provide an alert message to an electronic device associated with a retail facility, the alert message indicating that there is a high likelihood that an overall packaging of the first set of items in a retail facility is inefficient.

9. The system of claim 1, wherein, in response to a determination that the human operator deviations from the adjusted first packing configuration is at least a threshold error value, the control circuit is further configured to:
determine a difference between a first average count of shipping boxes used to ship the first set of items in accordance with the human operator deviations over a period of time and a second count of shipping boxes in accordance with the adjusted first packing configuration over the period of time, wherein a target error rate allows a user to control a number of iterations ran in determining a subsequent packing configuration in the first feedback loop; and
in response to the determination that the difference is greater than the target error rate, decrease the number of iterations ran to determine the subsequent packing configuration relative to a previous number of iterations ran determining the adjusted first packing configuration.

10. The system of claim 1, wherein, in response to a determination that the human operator deviations from the adjusted first packing configuration is at least a threshold error value, the control circuit is further configured to:
determine a difference between a first average count of shipping boxes used to ship the first set of items in accordance with the human operator deviations over a period of time and a second count of shipping boxes in accordance with the adjusted first packing configuration over the period of time, wherein a target error rate allows a user to control a number of iterations ran in determining a subsequent packing configuration in the first feedback loop; and
in response to the determination that the difference is equal to or greater than the target error rate, determine the subsequent packing configuration by running the same number of iterations as used in determining the adjusted first packing configuration.

11. A method for automatically determining packing configurations for packing items into shipping boxes at a retail facility, the method comprising:
executing, by a control circuit coupled to a database, a plurality of human operated packing stations, and a plurality of robot operated packing stations, a first feedback loop to compare past packing configurations of a first set of item with a first packing configuration for the first set of items and adjusting the first packing configuration based on this comparison, wherein the database stores item data, shipping box data, and packing configuration data including packing configurations for packing combinations of items into shipping boxes;
providing, by the control circuit, the adjusted first packing configuration to one or more of the plurality of human operated packing stations for a human to pack the first set of items into one or more shipping boxes in accordance with the adjusted first packing configuration;
executing, by the control circuit, a second feedback loop to receive data from the plurality of human operated packing stations comprising whether human operators packed the first set of items in accordance with the adjusted first packing configuration;
and determine data corresponding to human operator deviations from the adjusted first packing configuration based on the data received from the plurality of human operated packing stations; and
providing, by the control circuit, the adjusted first packing configuration to one or more of the plurality of human operated packing stations and the plurality of robot operated packing stations to pack additional orders of the first set of items into the one or more shipping boxes.

12. The method of claim 11, further comprising:
determining, by the control circuit, a hash value to associate with the first set of items based on weighted distributions of at least one or more item properties associated with the first set of items and a count of shipping boxes used to ship the first set of items; and
causing, by the control circuit, the database to store the hash value and associate the hash value with the first set of items and a count of the one or more shipping boxes associated with the adjusted first packing configuration, wherein the hash value is used to determine a reference count of shipping boxes used in part in determining a subsequent adjusted first packing configuration.

13. The method of claim 12, wherein, the comparison of the past packing configurations with the first packing configuration, further comprises:
determining, by the control circuit, a first count of shipping boxes associated with a previous hash value associated with the first set of items; and
continuously running, by the control circuit, iterations until a determination of the first packing configuration that uses the same count or less of shipping boxes as the first count of shipping boxes.

14. The method of claim 11, further comprising providing, by the control circuit, the adjusted first packing configuration to the plurality of robot operated packing stations when the human operator deviations from the adjusted first packing configuration is less than a threshold error value.

15. The method of claim 11, further comprising capturing, by one or more visual input devices assigned to each of the plurality of human operated packing stations, one or more images used to determine the human operator deviations from the adjusted first packing configuration.

16. The method of claim 11, wherein, in response to a determination that the human operator deviations from the adjusted first packing configuration is at least a threshold error value, further comprises:
determining, by the control circuit, whether a count of shipping boxes used to ship the first set of items in accordance with the human operator deviations is less than a first count of shipping boxes in accordance with the adjusted first packing configuration; and
in response to the determination that the count of shipping boxes used to ship the first set of items in accordance with the human operator deviations is less than the first count of shipping boxes, increasing, by the control circuit, a number of iterations ran to determine a subsequent packing configuration relative to a previous number of iterations ran determining the adjusted first packing configuration.

17. The method of claim 11, wherein, in response to a determination that the human operator deviations from the adjusted first packing configuration is at least a threshold error value, further comprises:
determining, by the control circuit, a difference between a first average count of shipping boxes used to ship the first set of items in accordance with the human operator deviations over a period of time and a second count of shipping boxes in accordance with the adjusted first packing configuration over the period of time, wherein a target error rate allows a user to control a number of iterations ran in determining a subsequent packing configuration in the first feedback loop; and
in response to the determination that the difference is less than the target error rate, increasing, by the control circuit, the number of iterations ran to determine the subsequent packing configuration relative to a previous number of iterations ran determining the adjusted first packing configuration.

18. The method of claim 11, wherein, in response to a determination that the human operator deviations from the adjusted first packing configuration is at least a threshold error value, further comprises:
determining, by the control circuit, a difference between a first average count of shipping boxes used to ship the first set of items in accordance with the human operator deviations over a period of time and a second count of shipping boxes in accordance with the adjusted first packing configuration over the period of time, wherein a target error rate allows a user to control a number of iterations ran in determining a subsequent packing configuration in the first feedback loop; and
in response to the determination that the difference is greater than the target error rate, providing, by the control circuit, an alert message to an electronic device associated with a retail facility, the alert message indicating that there is a high likelihood that an overall packaging of the first set of items in the retail facility is inefficient.

19. The method of claim 11, wherein, in response to a determination that the human operator deviations from the adjusted first packing configuration is at least a threshold error value, further comprises:
determining, by the control circuit, a difference between a first average count of shipping boxes used to ship the first set of items in accordance with the human operator deviations over a period of time and a second count of shipping boxes in accordance with the adjusted first packing configuration over the period of time, wherein a target error rate allows a user to control a number of iterations ran in determining a subsequent packing configuration in the first feedback loop; and
in response to the determination that the difference is greater than the target error rate, decreasing, by the control circuit, the number of iterations ran to determine the subsequent packing configuration relative to a previous number of iterations ran determining the adjusted first packing configuration.

20. The method of claim 11, wherein, in response to a determination that the human operator deviations from the adjusted first packing configuration is at least a threshold error value, further comprises:
determining, by the control circuit, a difference between a first average count of shipping boxes used to ship the first set of items in accordance with the human operator deviations over a period of time and a second count of shipping boxes in accordance with the adjusted first packing configuration over the period of time, wherein a target error rate allows a user to control a number of iterations ran in determining a subsequent packing configuration in the first feedback loop; and
in response to the determination that the difference is equal to or greater than the target error rate, determining, by the control circuit, the subsequent packing configuration by running the same number of iterations as used in determining the adjusted first packing configuration.
